(19) United States
(12) Patent Application Publication
(10) Pub. No.: US 2010/0182149 A1
(43) Pub. Date: Jul. 22, 2010

(54) Apparatus for and method of using rfid antenna configurations

(76) Inventor: Ronald A. Marino, Jackson, NJ (US)

Correspondence Address: DICKSTEIN SHAPIRO LLP, 1825 EYE STREET NW, Washington, DC, 20006-5403, US

(21) Appl. No.: 11/596,719

(22) PCT Filed: May 16, 2005
(86) PCT No.: PCT/US05/17106

§ 371 Date: Aug. 21, 2008

Related U.S. Application Data
(60) Provisional application No. 60/571,877, filed on May 18, 2004.

(51) Int. Cl. G08B 13/14

(52) U.S. Cl. 340/572.7

(57) ABSTRACT

In accordance with exemplary embodiments of the invention, antenna structures having specified geometries (e.g., serpentine, slot, etc.) are provided for incorporating into fixtures such as shelves. Preferred antenna structures of the invention can be used as tag reader antenna systems in RFID (radio frequency identification) applications and the like. In accordance with an exemplary embodiment, multiple RF (radio frequency) antennae are utilized as part of an intelligent station to track items comprising radio frequency identification (RFID) tags.

### CROSS-REFERENCE TO RELATED APPLICATION

This application claims the benefit of U.S. Provisional Patent Application No. 60/571,877 ('877 application), filed May 18, 2004, incorporated herein by reference in its entirety. This application expressly incorporates the following U.S. patent applications by reference in their entirety: U.S. patent application Ser. Nos. 10/338,892, 10/348,941, 60/346,388, 60/350,023, 60/469,024, and 60/479,846.

### BACKGROUND

Radio frequency identification (RFID) systems typically use one or more reader antennae to send radio frequency (RF) signals to items comprising RFID tags. The use of such RFID tags to identify an item or person is well known in the art. In response to the RF signals from a reader antenna, the RFID tags, when excited, produce a disturbance in the magnetic field (or electric field) that is detected by the reader antenna. Typically, such tags are passive tags that are excited or resonate in response to the RF signal from a reader antenna when the tags are within the detection range of the reader antenna.

The detection range of the RFID systems is typically limited by signal strength over short ranges, for example, frequently less than about one foot for 13.56 MHz systems. Therefore, portable reader units may be moved past a group of tagged items in order to detect all the tagged items, particularly where the tagged items are stored in a space significantly greater than the detection range of a stationary or fixed single reader antenna. Alternately, a large reader antenna with sufficient power and range to detect a larger number of tagged items may be used. However, such an antenna may be unwieldy and may increase the range of the radiated power beyond allowable limits. Furthermore, these reader antennae are often located in stores or other locations were space is at a premium and it is expensive and inconvenient to use such large reader antennae. In another possible solution, multiple small antennae may be used but such a configuration may be awkward to set up when space is at a premium and when wiring is preferred or required to be hidden.

Current RFID reader antennas are designed so that a maximum read range may be maintained between the antenna and associated tags, without violating FCC regulations regarding radiated emissions. Often times, when tagged items are stacked, the read range of an antenna is impeded due to “masking” that occurs through the stacking. As a result, the masking limits the number of tags that an antenna may read at a given time, and consequently affect the number of products that may be read. Furthermore, due to FCC regulations regarding radiated emissions, the reader antenna sizes cannot be adjusted to resolve such problems.

Resonant loop reader antenna systems are currently utilized in RFID applications, where numerous reader antennas are connected to a single reader. Each reader antenna may have its own tuning circuit that is used to match to the systems characteristic impedance. However, multiple reader antennae (or components thereof) cannot be individually controlled when they are connected by a single transmission cable to a reader unit.

### SUMMARY

In accordance with exemplary embodiments of the invention, antenna structures having specified geometries (e.g., serpentine, slot, patch, etc.) are provided for incorporating into fixtures such as shelves. Preferred antenna structures of the invention can be used as tag reader antenna systems in RFID (radio frequency identification) applications and the like. In accordance with an exemplary embodiment, multiple RF (radio frequency) antennae are utilized as part of an intelligent station to track items comprising radio frequency identification (RFID) tags.

### BRIEF DESCRIPTION OF THE DRAWINGS

FIG. 1 illustrates the front side of a display fixture in accordance with an exemplary embodiment of the invention;

FIG. 2 is a block diagram illustrating an exemplary antenna system in accordance with an exemplary embodiment of the invention;

FIG. 3 is a block diagram illustrating another exemplary antenna system incorporating primary, gondola, and shelf controllers which can be used to select antennae in accordance with an exemplary embodiment of the invention;

FIG. 4A and FIG. 4B illustrate antenna loop assemblies, wherein the assemblies are incorporated into a housing in accordance with an exemplary embodiment of the invention;

FIG. 5 illustrates serpentine and simple loop antennae structures in accordance with an exemplary embodiment of the invention;

FIG. 6 illustrates an antenna tuning circuit in accordance with an exemplary embodiment of the invention;

FIG. 7 illustrates slot antennae, wherein the antennae are incorporated into a housing in accordance with an exemplary embodiment of the invention;

FIG. 8A and FIG. 8B illustrate coaxial feed configurations for a slot antenna in accordance with an exemplary embodiment of the invention;

FIG. 9A and FIG. 9B illustrate microstrip feed configurations for a slot antenna in accordance with an exemplary embodiment of the invention; and

FIG. 10 illustrates slot antennae in proximity to tagged items in accordance with an exemplary embodiment of the invention.

### DETAILED DESCRIPTION

Preferred embodiments and applications of the invention will now be described. Other embodiments may be realized and changes may be made to the disclosed embodiments without departing from the spirit or scope of the invention. Although the preferred embodiments disclosed herein have been particularly described as applied to the field of RFID systems, it should be readily apparent that the invention may be embodied in any technology having the same or similar problems.

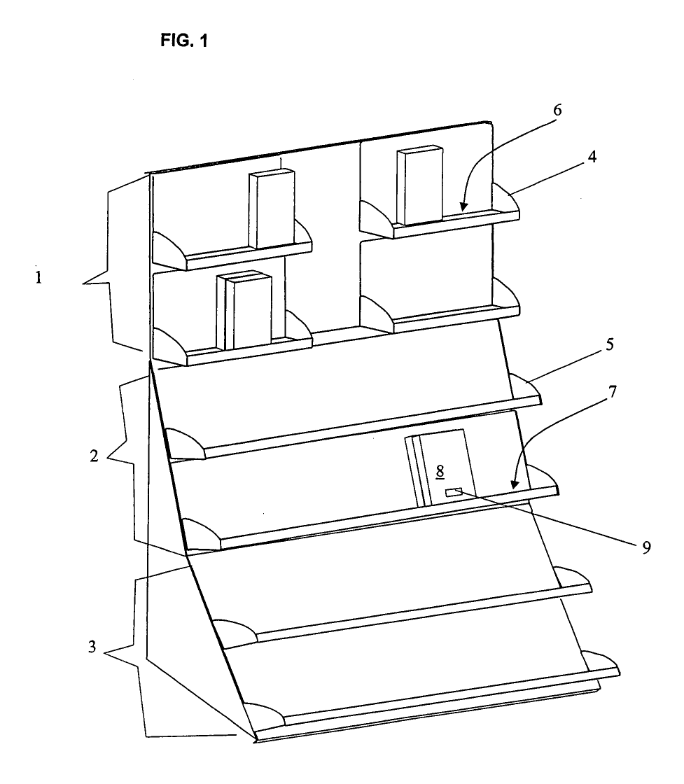

FIG. 1 shows a front view of a display fixture, incorporating three backplanes 1, 2, and 3 with attached shelves 4 and 5. In the examples herein, antennae will be described that may be placed in, for example, approximately horizontal planes as at positions 6 and 7 in accordance with preferred embodiments of the invention. This display fixture may be useful for monitoring inventory of RFID tagged items such as optical disk media 8 (shown on the shelves). Preferably optical disk media 8 has an attached RFID tag 9 that can be detected by an RFID system. The display fixture of FIG. 1 is used as an example here of a preferred embodiment, but it should be understood that other fixtures or non-fixtures may embody the invention, and that the antennae described here can be used in orientations other than the exemplary horizontal orientation.

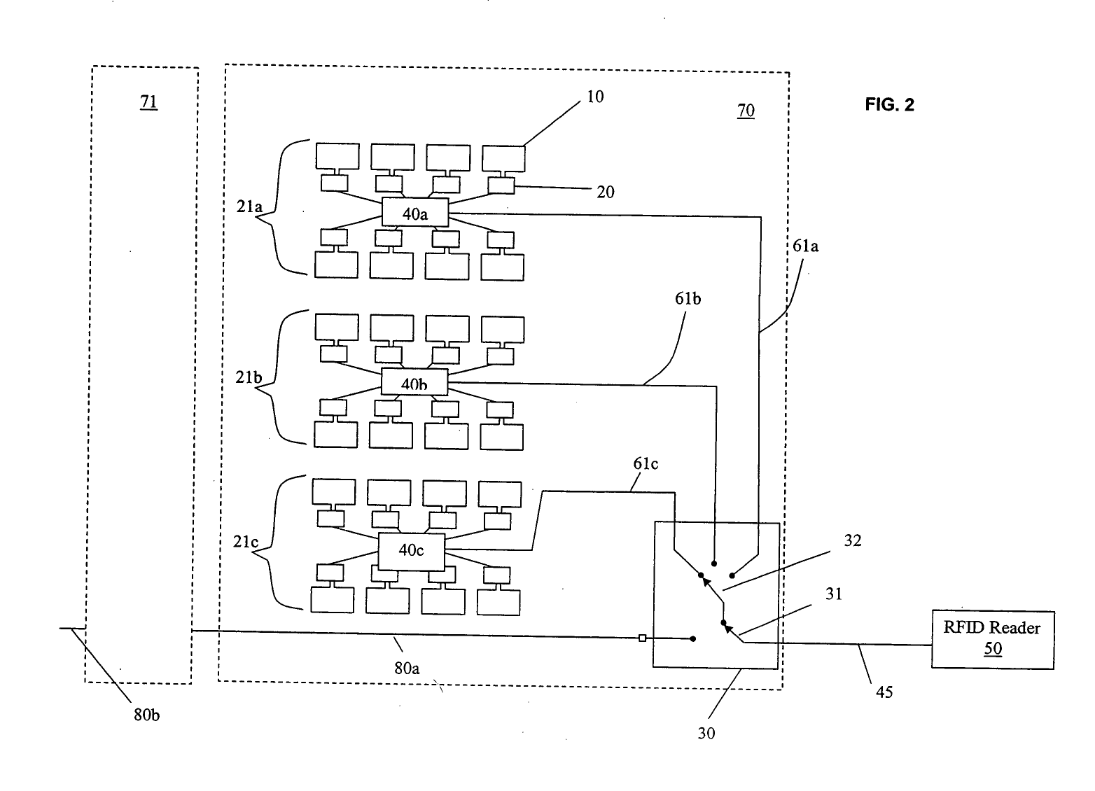

In accordance with an exemplary embodiment of the invention, a multiple RFID antenna system is illustrated in FIG. 2. The exemplary antenna system includes reader antennae 10, with associated antenna boards 20, gondola controllers 30, shelf controllers 40a, 40b, 40c, and an RFID reader 50. It should be apparent that antenna boards 20 may include tuning components and other components (e.g., gondola controllers 30, shelf controllers 40a, 40b, 40c) and may include logic and switching controls as necessary to perform the operations described herein. In one embodiment, the antenna board may comprise reader antenna 10. The antenna boards 20 may not be needed for some antenna designs. If present, they may include components such as antenna tuning circuitry.

The RFID feed system shown in FIG. 2 incorporates an RFID reader 50 and a feed line 45 (e.g., a coaxial cable) leading to a structure 70 (e.g., a store display fixture or “gondola”). When additional gondolas are used, the additional gondolas (e.g., gondola 71) may be joined into the circuit as described below.

The RF signal in cable 45 may be routed by gondola controller 30 so that it is sent to shelves on gondola 70, or bypasses gondola 70 and continues on to additional gondolas such as gondola 71. In this embodiment, the term “shelf” refers to one shelf or a group of shelves served by a single shelf controller 40a, 40b, 40c, and the term “gondola” refers to a structure including one or more shelves. The terms “shelf” and “gondola” however are not meant to be limiting as to the physical attributes of any structure that may be used to implement embodiments of the invention, but used merely for convenience in explaining this embodiment. Any known structure for storing, housing, or otherwise supporting an object may be used in implementing the various embodiments of the invention. For example, an RF switch 31 may either cause the RF signal to bypass the gondola 70, and continue on through connection 80a to gondola 71, or the RF switch 31 may cause the RF signal to feed into gondola 70. Furthermore, one or more additional RF switches 32 may route the RF signal to a particular shelf, for example, through connection 61a to shelf 21a upon gondola 70. In a preferred embodiment, a shelf controller (e.g., controller 40a) may switch the RF signal to one or more of the antenna boards 20 and thence to antenna 10. It will be appreciated that while FIG. 2 shows three shelves on gondola 70, and eight antennas per shelf, any suitable number of shelves and antennae per shelf may be used in accordance with preferred embodiments of the invention.

The use of RF switch 31 may result in an “insertion loss.” That is, some RF power may be lost as the signal passes through the switch. Thus, the level of RF power reaching gondola 71 and successive additional gondolas may be less than the RF power reaching gondola 70. In one embodiment, however, the RF power may be approximately equal at each antenna 10. For example, it may be desired to have the RF power level at a given antenna 10 high enough to read all RFID tags attached to items resting on the given antenna 10, but not so high as to read RFID tags attached to items resting on adjacent antennae. RF attenuators may be used in accordance with preferred embodiments of the invention to adjust (e.g., equalize) the power level at each antenna 10. For example, RF attenuators (not shown) could be placed between a shelf controller (e.g., controller 40a) and each antenna 10 and used to regulate the RF power at each gondola. The RF attenuators may be chosen, for example, to attenuate the RF power more at gondola 70 and less at gondola 71 and successive additional gondolas. In one embodiment, RF attenuators may be placed at other locations within the circuitry (e.g., in connections 61a, 61b, 61c, or between switches 31 and 32) to achieve the same result, as will be apparent to those skilled in the art.

In accordance with a preferred embodiment of the invention, a plurality of antennae 10 optionally having associated antenna boards 20, shelf controllers 40a, 40b, 40c, gondola controllers 30, and associated wiring, may be contained in or on a physical structure, as shown, for example, in FIG. 2 as gondola 70 and gondola 71.

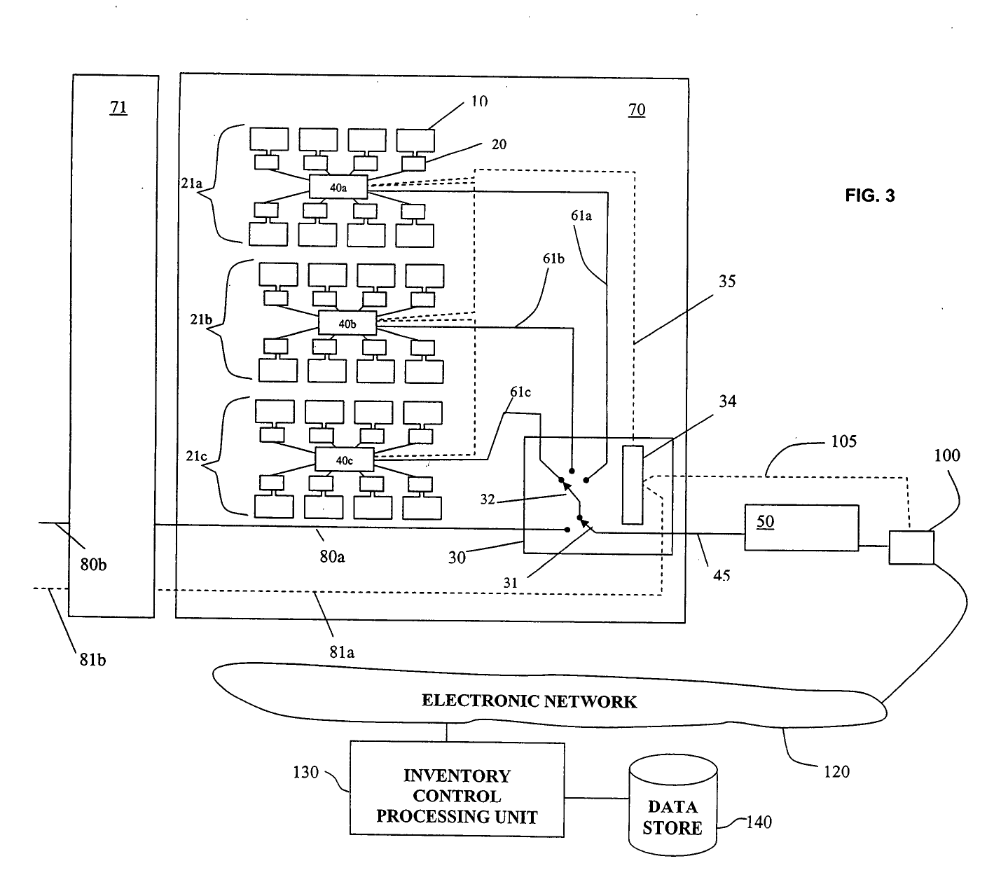

FIG. 3 illustrates an exemplary embodiment of the invention wherein reader 50 is controlled by primary controller 100 which sends commands or control signals along control cable 105 to select which antenna is active at any time. Between gondolas (70, 71, etc.), the commands or control signals may be carried on control cable 81a and 81b. Within a gondola the commands or control signals may be carried by cable or cables 35. The primary controller 100 may be a processing device (e.g., microprocessor, discrete logic circuit, application specific integrated circuit (ASIC), programmable logic circuit, digital signal processor (DSP), etc.). Furthermore, the shelves may also be configured with shelf controllers 40a, 40b, 40c, and the gondola controller 30 with circuitry 34 for communicating with the primary controller 100 to, for example, select antennae. The shelf controllers 40a, 40b, 40c and gondola controllers 30 may also be microprocessors (or other processing devices) with sufficient outputs to control the RF switches connected to their associated antennae.

In one preferred embodiment, primary controller 100 may selectively operate any of the switches by sending commands containing a unique address associated with antenna 10 through, for example, a digital data communication cable 105. The addresses could be transmitted through the use of addressable switches (e.g., switches identical or functionally equivalent to a Dallas Semiconductor DS2405 “1-Wire®” addressable switch). Each such addressable switch, for example, provides a single output that may be used for switching a single antenna. Preferably, the primary controller 100 may selectively operate any or all the switches by utilizing one or more gondola controllers 30 and/or shelf controllers 40a, 40b, 40c. For example, these controllers may be a processing device, which can provide multiple outputs for switching more than one antenna (e.g., all the antennas in proximity to the shelf controller 40a, 40b, 40c). The primary controller 100 may also be any processing device. Communications between the primary controller 100 and the gondola controller 30 can be implemented by using communication signals in accordance with well known communication protocols (e.g., CAN bus, RS-232, RS-485 serial protocols, Ethernet protocols, Token Ring networking protocols, etc.). Likewise communications between the gondola controller 30 and shelf controller 40a, 40b, 40c may be implemented by the same or different communication protocols.

The term “intelligent station” generally refers to equipment, such as a shelf, which may include controllers, switches and/or tuning circuitry, and/or antennae. More than one intelligent station may be connected together and connected to or incorporated with an RFID reader. A primary controller can be used to run the RFID reader and the intelligent stations. The primary controller itself may be controlled by application software residing on a computer. In one embodiment, an “intelligent station” is an “intelligent shelf.”

In a preferred embodiment, the intelligent shelf system is controlled through an electronic network 120, as shown in FIG. 3. A controlling system that controls the intelligent shelf system will send command data to the primary controller 100 via Ethernet, RS-232 or other signaling protocol. These commands include but are not limited to instructions for operating the RFID reader unit 50 and switches associated with gondola controllers 30 and shelf controllers 40a, 40b, 40c. The primary controller 100 is programmed to interpret the commands that are transmitted through the unit. If a command is intended for the reader unit 50, the primary controller 100 passes that command to the reader unit 50. Other commands could be used for selecting antennae 10, and these commands will be processed if necessary by primary controller 100 to determine what data should be passed through digital data communication cable 105 to the gondola controllers 30 and potentially on to the shelf controllers 40a, 40b, 40c.

Likewise, the shelf controllers 40a, 40b, 40c, and the gondola controller controllers 30 can pass data back to the primary controller 100, as can the reader unit 50. The primary controller 100 then relays result data back to the controlling system through the electronic network 120. The inventory control processing unit 130, shown in FIG. 3, is one example of such a controlling system. As discussed further herein with respect to the intelligent shelf system, the electronic network and controlling system are used interchangeably to depict that the intelligent shelf system may be controlled by the controlling system connected to the intelligent shelf system through an electronic network 120.

Primary controller 100 of FIG. 3 can determine whether a command from the electronic network 120 should be sent to reader 50, or should be sent through the communication cable 105. Primary controller 100 can relay data it receives from the communication cable 105, and from reader unit 50, back to the electronic network 120. In one preferred embodiment, the electronic network issues a command to read one or more antennae. In this embodiment, the primary controller 100 can (a) set the proper switch or switches for that antenna, (b) activate the reader, (c) receive data back from the reader, (d) deactivate the reader, and (e) send the data back to the electronic network 120. Further details of the processing of command signals from a host by the controller can be found, for example, in U.S. patent application Ser. No. 10/338,892 (filed Jan. 9, 2003), which has been incorporated by reference in its entirety herein.

In a preferred embodiment, the primary controller 100 can be placed between the electronic network 120 and the reader as shown, for example, in FIG. 3. In this embodiment, a variety of reader types (e.g., readers 50) can be used as needed. The commands from the electronic network to the controller may be transmitted using generic control data (e.g., not reader-specific), thus allowing for expanded uses by various types of readers. For example, the electronic network can send a “read antennas” command to the controller. The controller in turn can then translate this command into the appropriate command syntax required by each reader unit. Likewise, the controller can also receive the response syntax from the reader unit (which may differ based on the type of the reader unit), and parse it into a generic response back to the electronic network 120. The command and response syntax may differ for each type of reader unit 50, but the primary controller 100 makes this transparent to the electronic network 120.

In FIG. 3, a portion of the control cable 81a that extends beyond shelf 70, and a portion of the RF cable 80a extends beyond shelf 70, are shown outside of the shelf. However, as would be recognized by those skilled in the art, these extended portions of the cables may also be contained within the shelf or another structure. Additional extended control cable portions 81b and additional extended RF cable portions 80b may be used to connect to more shelves or groups of shelves. Likewise, additional shelves (not shown) may be added to groups of shelves, for example, to gondolas 70 or 71 as would be apparent to those skilled in the art.

The item information data collected by the reader units 50 from each of the intelligent shelves is transmitted to an inventory control processing unit 130. The inventory control processing unit 130 is typically configured to receive item information from the intelligent shelves. The inventory control processing unit 130 is typically connected to the intelligent shelves over an electronic network 120 and is also associated with an appropriate data store 140 that stores inventory related data including reference tables and also program code and configuration information relevant to inventory control or warehousing. The inventory control processing unit 130 is also programmed and configured to perform inventory control functions that are well known to those skilled in the art. For example, some of the functions performed by an inventory control (or warehousing) unit include: storing and tracking quantities of inventoried items on hand, daily movements or sales of various items, tracking positions or locations of various items, etc.

In operation, the inventory control system would obtain item information from the intelligent shelves that are connected to the inventory control processing unit 130 through an electronic network 120. In one preferred embodiment, one or more intelligent shelves are controlled by inventory control processing unit 130. Inventory control processing unit 130 can determine when the reader units 50 are under control of primary controller 100 and poll the antennae 10 to obtain item inventory information. In an alternate embodiment, the controller(s) 100 may be programmed to periodically poll the connected multiple antennae for item information and then transmit the determined item information to the inventory control processing unit using a reverse “push” model of data transmission. In a further embodiment, the polling and data transmission of item information by the primary controller 100 may be event driven, for example, triggered by a periodic replenishment of inventoried items on the intelligent shelves. In each case, the primary controller 100 would selectively energize the multiple antennae connected to reader 50 to determine item information from the RFID tags associated with the items to be inventoried.

Once the item information is received from the reader units 50 of the intelligent shelves, the inventory control processing unit 130 processes the received item information using, for example, programmed logic, code, and data at the inventory control processing unit 130 and at the associated data store 140. The processed item information is then typically stored at the data store 140 for future use in the inventory control system and method of the invention.

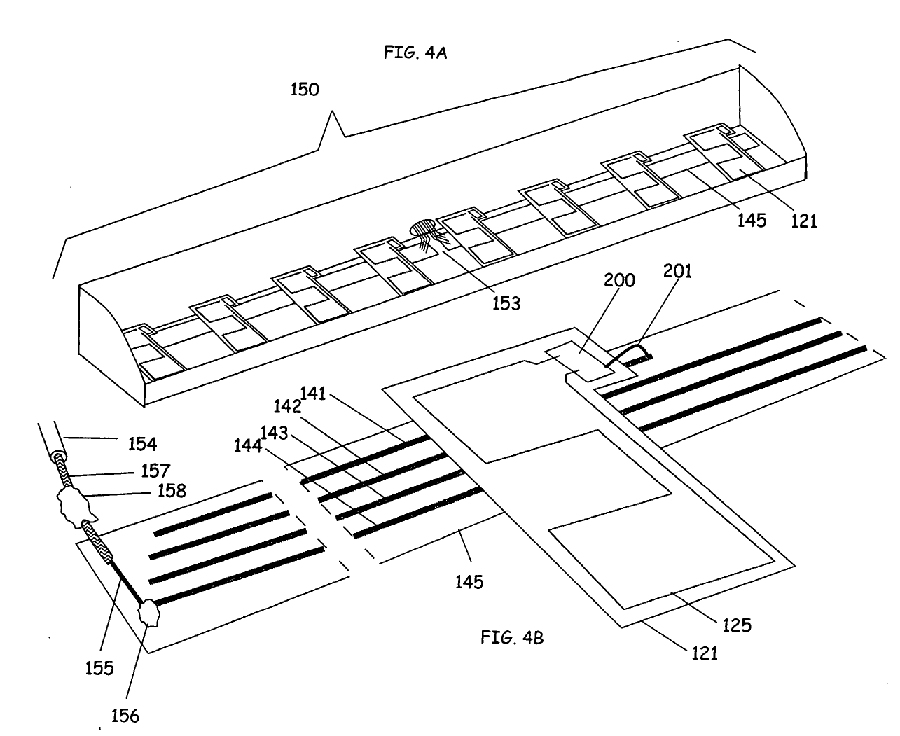

FIG. 4A shows a shelf 150 with eight individual antenna boards 121, spaced along the length of the shelf. The antenna boards 121 may be raised slightly above the “floor” of the shelf, for example, on standoffs, especially if the shelf is metal. One or more connector boards 145 (e.g., bearing microstrip traces 141, 142, 143, 144) run along the shelf, for example, under the antenna boards 121, in order to connect the antenna boards with external circuitry. Alternatively, a connector or connectors (e.g., coaxial cable) may be used to connect the antenna boards with external circuitry. Since circuit board dimensions larger than 24″ may be more difficult or more expensive to fabricate than smaller boards, two connector boards may preferably be used, for example, in a shelf 150 that is approximately 51″ long. At a convenient point such as the center 153, the microstrip traces have connection points for attaching to switching and/or tuning circuitry, that may be on or within the shelf, or external to the shelf, for example, behind the structure on which the shelf is supported.

FIG. 4B gives a close up view of an antenna board 121 and a portion of connector board 145. The antenna board 121 contains an antenna trace (e.g., serpentine antenna trace 125). The antenna trace is connected to circuitry 200, for example, a tuning circuit (e.g., on the board as shown here, or off the board) incorporating components such as capacitors. Preferably this circuitry 200 is on the underside of the antenna board 121, so that the top surface of the antenna board 121 is smooth without obstructions, to allow a decorative laminate, board, or other nonmetallic covering to be placed on top of the antenna boards.

Circuitry 200 is joined by connection 201 to connector board or boards 145, which bears on one surface one or more microstrip connectors such as 141-144. The opposite surface of connector board 145 is preferably a ground plane, such as a plated layer or foil layer. Preferably, the microstrip connectors are on the top of the connector board and the ground plane is on the bottom. The widths and separations of microstrip connectors 141-144 are designed to give the proper RF impedance (e.g., a 50 ohm impedance). Besides its connection 201 to the connector board, the circuitry 200 may be connected to a circuit ground, which may be provided by a connection to the metal shelf, for example, through a bolt or stud (not shown).

At a convenient point 153, connector board 144 is joined to additional circuitry, for example, switching circuitry, and thence to an RFID reader. At point 153, for example, a coaxial cable 154 may be connected at its center conductor 155, through a solder joint 156, to microstrip conductor 144. The coaxial cable 154 external conductor or shield 157 may in turn be connected by solder joint 158 to ground, for example, to the metal shelf 150.

Each of the microstrip conductors 141-144 may be connected at point 153 to a coaxial cable such as cable 154. Alternately, at point 153, the microstrip conductors may be connected to a shelf controller 40a, 40b, 40c (e.g., as previously described above but not shown in FIG. 4B).

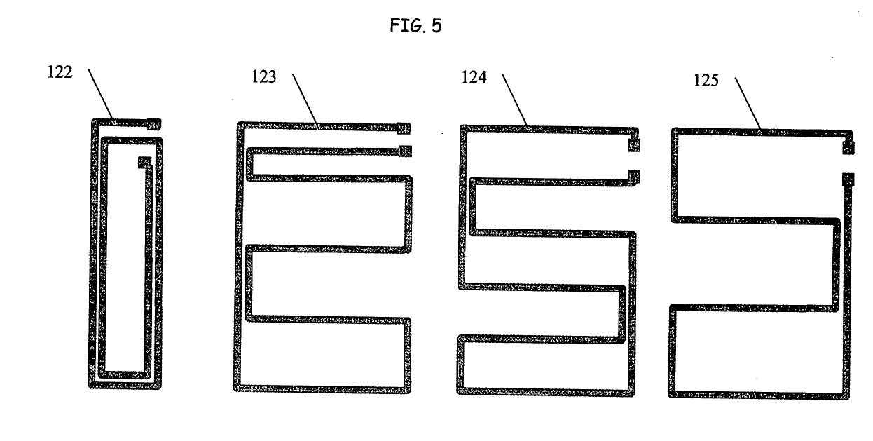

FIG. 5 shows exemplary antenna trace structures in accordance with preferred embodiments of the invention, including loop antenna 122 (having one or more loops) and serpentine antennae 123-125. In accordance with a preferred embodiment, one or more of the antenna trace structures are embedded or contained on an antenna board (e.g., such as antenna board 121 (FIG. 4B)).

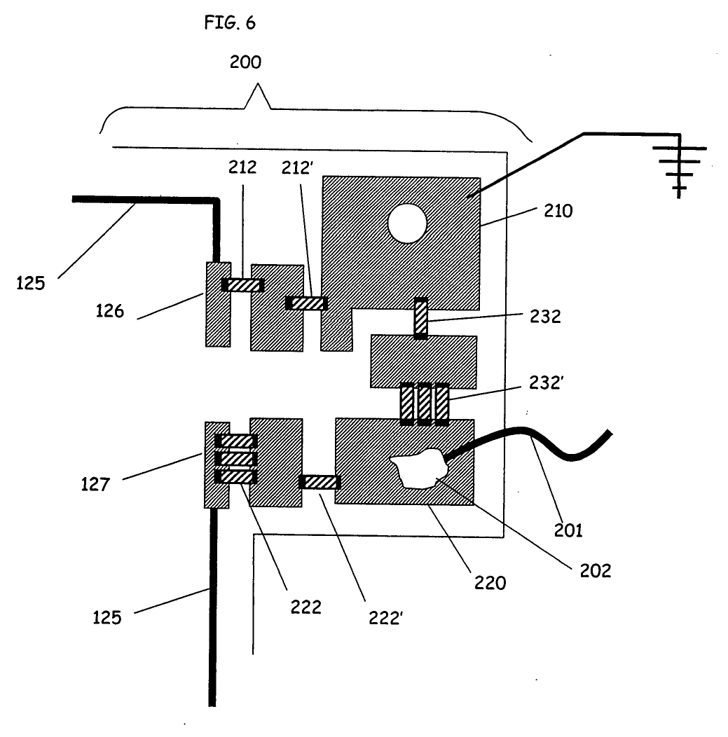

FIG. 6 is a detailed view of exemplary tuning circuitry that may be included as circuitry 200 on antenna board 121. The shaded areas represent conductive areas or plated areas. Circuitry 200 may be connected to the ends of antenna trace 125 at connection pads (such as solder pads) 126 and 127. A ground connection may be provided at pad 210, for example, with a hole for attaching to a grounding screw or bolt. The ground connection at pad 210 may connect to a first end of the antenna trace 125, at pad 126, through components 212 and 212′. These may be one or more capacitors. Depending on the tuning requirements, component 212 may also be a short (a “short” as used here indicates a deliberate zero resistance). If the component 212 is one or more capacitors, component 212′ may likewise be one or more capacitors, preferably with the same capacitance as component 212. The use of two groups of capacitors 212 and 212′ may be useful for distributing a voltage drop that would otherwise exceed the desired voltage across a single group of capacitors.

Connection 201 previously described may be provided for attaching to RF signal pad 220. For example, a solder connection 202 may be used. RF signal pad 220 in turn may be connected to the second end of antenna trace 125, at pad 127, through components 222 and 222′. Component 222 may be one or more capacitors, and component 222′ a short. Alternately, component 222 may be a short, and component 222′ may be one or more capacitors. Alternately, both components 222 and 222′ may be one or more capacitors, preferably with the capacitance of 222 and 222′ being approximately equal. This last alternative may be useful for distributing the voltage drop over the capacitors.

The ground pad 210 and the RF signal pad 220 may be connected through components 232 and 232′. Component 232 may be one or more capacitors, and component 232′ a short. Alternately, component 232 may be a short, and component 232′ one or more capacitors. Alternately, both component 232 and 232′ may be one or more capacitors, preferably with the capacitance of 232 and 232′ being approximately equal. In one embodiment, this last alternative is useful for distributing the voltage drop over the capacitors.

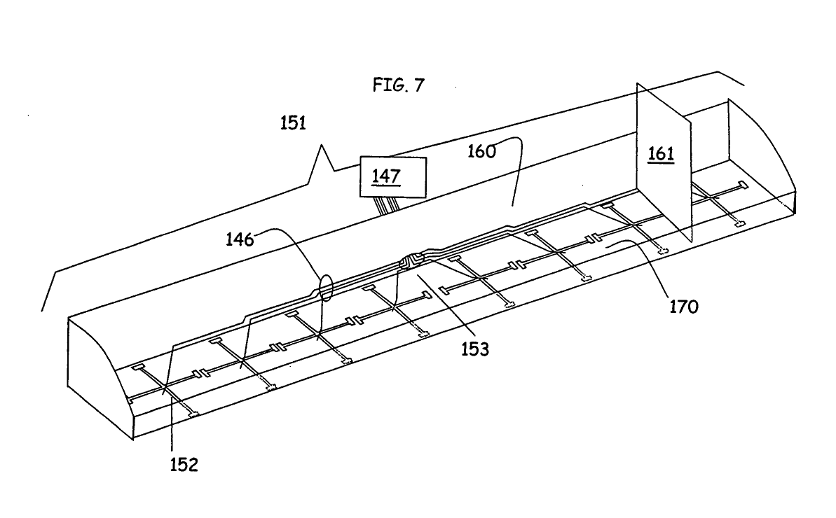

FIG. 7 illustrates an antenna structure 152, in accordance with a preferred embodiment of the invention, as incorporated in a shelf 151. As shown, the antenna structure 152 has a “slot” configuration, with 8 such antenna structures spaced along the length of the shelf. In accordance with a preferred embodiment], the antennas 152 may be cut into the bottom surface 170 of the shelf (e.g., made of metal), or may be provided on a separate piece or pieces of material (e.g., metal) to be placed into the shelf. It should be understood that any number of antennas could be utilized, or that the antennas could in other applications be placed in the shelf back 160 (antennas not shown in FIG. 7) or in dividers 161 placed in or on the shelf (antenna not shown in FIG. 7). One or more connector means 146 run from the antennas to one or more convenient points 153 from which the connector means may pass to additional circuitry 147 such as switching and tuning circuitry, and thence to a reader (not shown). Alternately the additional circuitry 147 may be contained within shelf 151. The additional circuitry may include a shelf controller. The connector means 146 may be, for example, coaxial cables or microstrip conductors or a combination thereof. If microstrip connectors are used, since circuit board dimensions larger than 24″ may be more difficult or more expensive to fabricate than smaller boards, two or more connector boards may preferably be used, for example, in a shelf 151, that is approximately 51″ long. In a preferred embodiment, the slot antennae may be constructed using PC board materials or by cutting slots in metal plates. It is understood that slot antennae may be constructed using any suitable material (e.g., PC board materials, metal plates). This exemplary antenna structure can be referred to as a “radiating structure” or “radiating mechanism.”

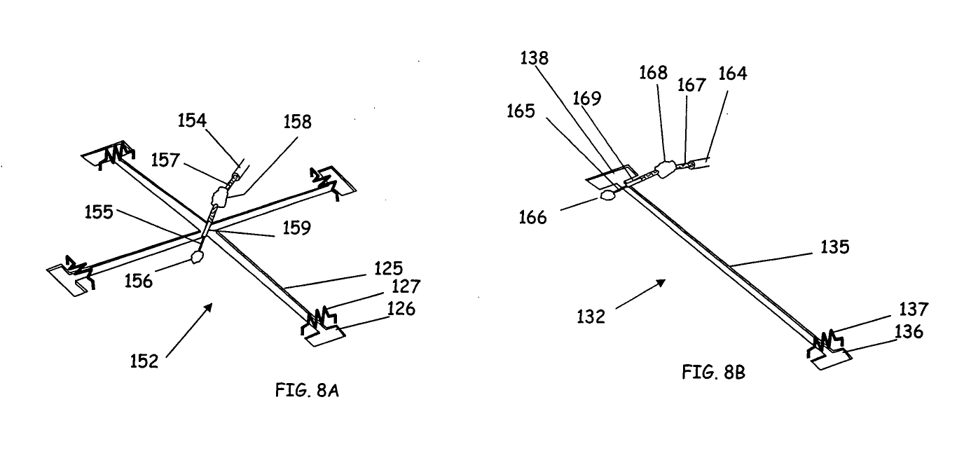

FIG. 8A gives a close up view of a slot antenna 152 having a cross-shaped geometry, with the slot arms being approximately perpendicular to each other, in accordance with a preferred embodiment of the invention. Although the slot arms are illustrated in FIG. 8A as being substantially perpendicular (i.e., where each arm is separated from another at an angle of approximately 90-degrees to each other, it should be apparent that any configuration of intersecting arms (e.g., where arms are separated from another at different angles) may be used in implementing the invention. As illustrated, the antenna has four slots arms 125, each having an end opening 126. Any number (e.g., 1, 2, 3, 4, 5, etc.) of slot arms may be used in implementing the invention. Indeed, any number of different geometric shapes may be used in implementing the arms or other components of the invention (e.g., the slot may be wider in the central portion of the slot than at one or more ends of the slot).

In one embodiment, a resistor 127 (e.g., 200 ohm) may be connected across the slot arm (e.g., just short of the end opening 126). Thus, for example, where each of the four slot arms on the antenna 120 have a 200 ohm resistor, the antenna has four 200 ohm resistors in parallel, giving an effective impedance of 50 ohms. The resistors provide a broadband impedance match, and one or more (or all) of the resistors may be omitted depending on the bandwidth of the antenna. Other feed locations besides the center are also possible, as is the use of more than one feed per antenna.

In accordance with a preferred embodiment, the antenna 152 may be fed an RF signal by a coaxial cable 154 (or microstrip conductor as described above). In the illustrated implementation, for example, the center coaxial conductor 155 may be soldered or connected to an interior quadrant point 156 of the cross-shaped antenna 152. The outer coaxial shield or ground conductor 157 may be soldered or connected at the diagonally opposite interior quadrant point 158. It will be understood that the center coaxial conductor 155 and the outer coaxial shield 157 can be separated by an insulating material 159. Solder is a suitable connection method (e.g., for metals such as copper and the like), but a mechanical connection such as a screw, bolt, clamp, or other type (not shown) may also be utilized (e.g., with metals such as steel).

FIG. 8B gives a close up view of a line-shaped slot antenna 132 in accordance with a preferred embodiment of the invention. In the illustrated implementation, this antenna has one slot arm 135 having at each end an opening 136, 138. The slot arm 135 has a width chosen for good RF performance, for example, at the UHF frequency being used. In a preferred embodiment, the width of slot arm 135 can be chosen for good RF performance at any desired frequency or frequency range. In another preferred embodiment, the width of slot arm 135 can be adjustable such that the slot arm can be reconfigured for good RF performance at a variety of frequencies and frequency ranges. In yet another embodiment, the width of the slot may be greater at one or more ends than in the central portion of the slot.

In one embodiment, at a first end of the slot arm, just short of the end opening 136, a resistor 137 (e.g., 50 ohm) may be connected across the slot arm. As with the cross-shaped antenna structure 152 of FIG. 8A, the resistor 137 provides a broadband impedance match, and may be omitted depending on the bandwidth of the antenna.

In a preferred embodiment, the line-shaped slot antenna 132 may be fed an RF signal by a coaxial cable 164 (or microstrip conductor as described above). The center coaxial conductor 165 may be soldered or connected at the second end of the slot arm, one side of the slot arm at point 166 as shown, just short of the end opening 138. The outer coaxial shield or ground conductor 167 may be soldered or connected on the other side of the slot arm, at point 168 also just short of the end opening 138. Solder is a suitable connection method, but a mechanical connection such as a screw, bolt, or clamp (not shown) may also be utilized. It will be understood that the center coaxial conductor 165 and the outer coaxial shield 167 can be separated by an insulating material 169.

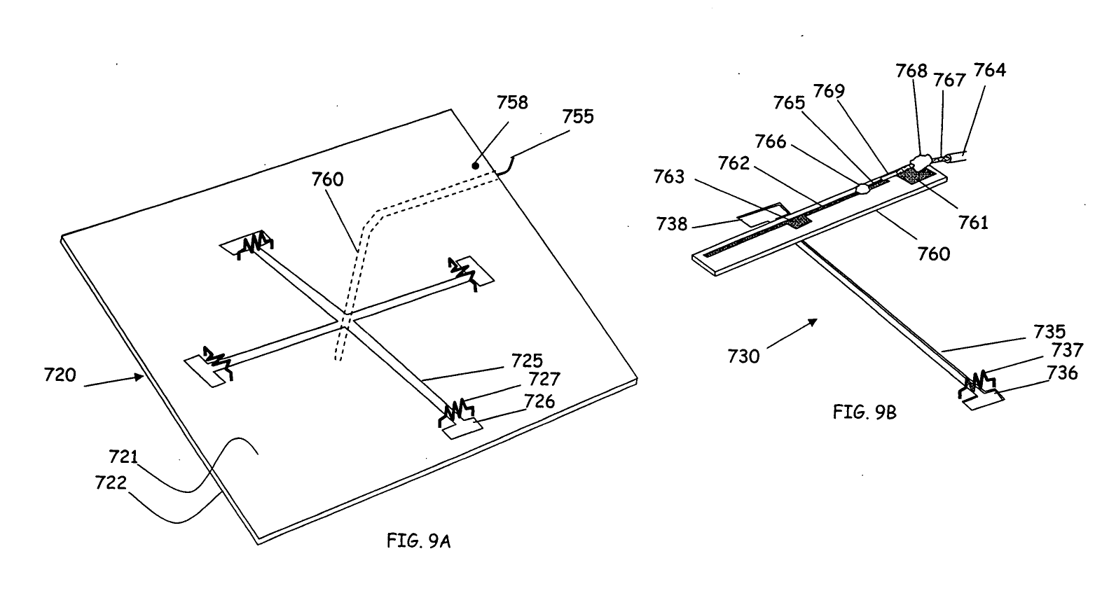

FIG. 9A shows a cross-shaped antenna 720 in accordance with a preferred embodiment of the invention made on a printed circuit board having a metal surface 721 (e.g., a plated surface) and an opposite surface 722 that has the plating removed (except for the microstrip conductor 760 described below). The antenna has four slots arms 725 formed on the metal surface 721 where no plating is present. Each slot arm 725 may have an end area 726 where no plating is present. Preferably, the slot arms 725 have a width chosen for good RF performance at the UHF frequency being used. At the end of one or more of slot arms 725, preferably, just short of the end area 726, a resistor 727 (e.g., 200 ohm) may be connected across the slot arm as shown. In another embodiment, resistor 727 is omitted. As noted above, where each of the four slot arms on the antenna 720 have, for example, a 200 ohm resistor, the resistors are in parallel, giving an effective impedance of 50 ohms. A linear slot (or other shaped) antenna (not shown) could likewise be constructed using printed circuit technology. It should be understood that any suitable number of slot arms can be provided for one or more antennae.

In accordance with a preferred embodiment, the antenna 720 is fed an RF signal by a microstrip conductor 760 on the surface 722 of the antenna opposite from the surface 721 on which the cross-shaped antenna is made. In the illustrated embodiment, the microstrip conductor 760 passes on a diagonal across the central area of the cross-shaped antenna. The microstrip conductor 760 may be connected to external circuitry by a suitable connector. The microstrip conductor 760 may be connected at point 755 to an RF signal, while the plated surface 721 may be connected to ground as shown by point 758.

FIG. 9B provides a close up view of a line-shaped slot antenna 730 in accordance with a preferred embodiment of the invention. The antenna has one slot arm 735 having at each end an opening 736, 738. Preferably, the slot arm 735 has a width chosen for good RF performance at the UHF frequency being used, although any suitable width can be chosen for good RF performance at a variety of frequencies and/or frequency ranges. At one end of the slot arm, just short of the end opening 136, a resistor 137 (e.g., 50 ohm) may be connected across the slot arm as shown.

In accordance with a preferred embodiment, the antenna 730 may be fed an RF signal by a coaxial cable 764 (or microstrip conductor as described above). The center coaxial conductor 765 may be soldered or otherwise connected at point 766 to a feed stub 760 composed of an insulating material such as PCB board having on it a microstrip line 762 that may extend across slot arm 735 near one end of the slot arm. One or more metallic patch areas 763 may be used to tune the feed stub. The outer coaxial shield or ground conductor 767 may be soldered or connected to a pad 761 (e.g., a grounding pad) that is connected (e.g., through-plating) to a metallic pad on the opposite side of the PCB board, in proximity to or directly connected to the metal substrate in which slot arm 730 is formed. The connection to the metal substrate may be with solder, mechanical connector, or by capacitive coupling. Insulating material 769 may be provided between the center coaxial conductor 765 of coaxial cable 764 and outer shield 767.

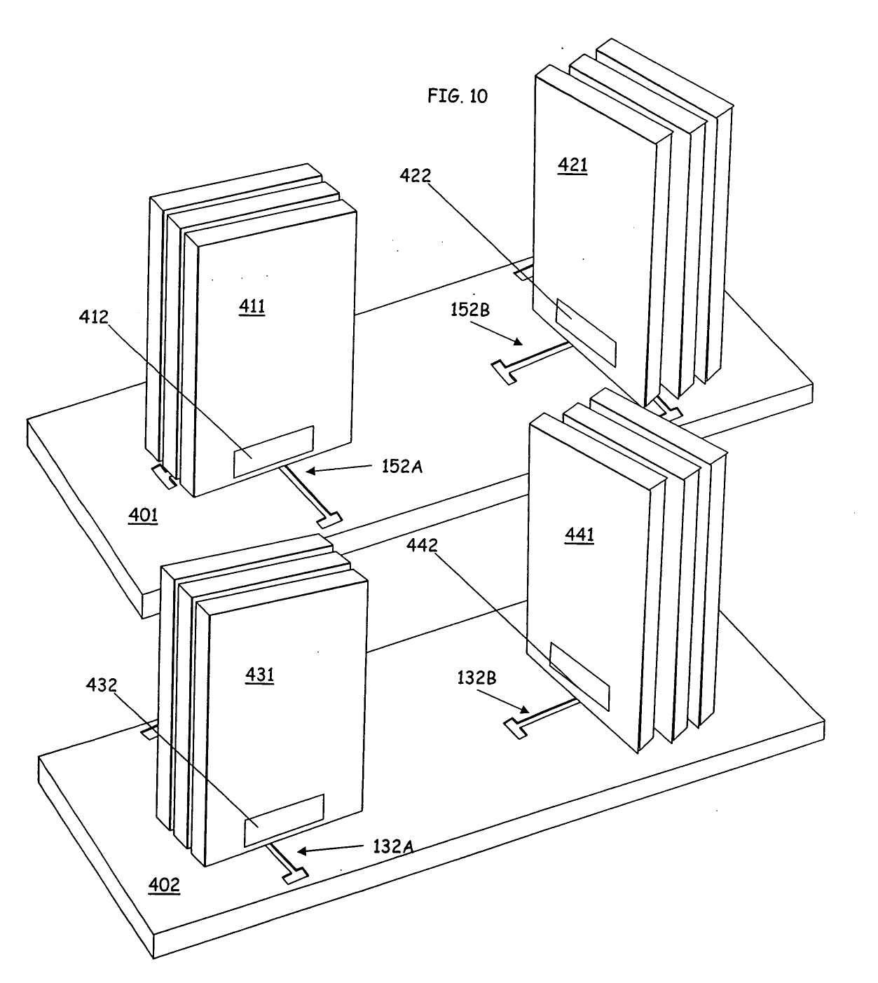

FIG. 10 depicts exemplary applications for slot antennas in accordance with preferred embodiments of the invention. Shelf 401, for example, is shown having cross-shaped antennas 152A and 152B. On top of antenna 152A are placed several objects 411 such as DVD cases, in a “face-forward” orientation. Each object 411 preferably has an RFID tag 412 placed at a location suitable for being detected by slot antenna 152A. This location may preferably be near the bottom of object 411, that is, near the antenna 152A. This location of the RFID tag may be outside the object as shown, or under the object, inside the object, or in any feasible location.

As illustrated, on top of the antenna 152B are several objects 421 such as DVD cases, in a “bookshelf” (edge-forward) orientation. Each object 421 has an RFID tag 422 placed at a location suitable for being detected by slot antenna 152B.

Shelf 402 is shown having linear-shaped antennas 132A and 132B. As illustrated, antenna 132A runs front to back on the shelf, and upon it are placed several objects 431 such as DVD cases, in a “face-forward” orientation. Each object 431 has an RFID tag 432 placed at a location suitable for being detected by slot antenna 132A.

On top of antenna 132B are several objects 441 such as DVD cases, in a “bookshelf” orientation. Each object 441 has an RFID tag 442 placed at a location suitable for being detected by slot antenna 132B.

Preferably, linear shaped slot antenna 132A is used to read objects, for example, in a forward-facing orientation, whereas, the linear shaped slot antenna 132B is used to read objects, as shown, in the bookshelf orientation.

It should be understood that other kinds of electrical power (e.g., direct current (DC)) may be used by the antenna system in addition to (or substitution for) RF power. For example, direct current (DC) may be used by the gondola controller 30, as well as by the shelf controllers 40a, etc. and the antenna boards 20. One or more dedicated wires may provide such electrical power, or it may be incorporated into the digital communication highway or with an RF cable. An RF cable may be configured using two conductors (e.g., coaxial cable), wherein both the center conductor and the sheath conductor are utilized in the system. While the RF cable carries an RF signal, a DC voltage may be superimposed on the RF signal, in the same RF cable, to provide DC power to intelligent stations. Voltage regulators may subsequently be used to control or decrease excessive voltages to within usable limits.

While preferred embodiments of the invention have been described and illustrated, it should be apparent that many modifications to the embodiments and implementations of the invention can be made without departing from the spirit or scope of the invention. The implementation of 8 slot antenna structures 152 on a single shelf 151 in FIG. 7, for example, may instead be implemented in 8 (or any number of) separate antenna boards (e.g., antenna boards 121 (FIG. 4B)) for mounting on (or incorporating in) a shelf or other supporting structure. Any number of the same or combination of different antenna structures (e.g., loop, serpentine, slot, patch, etc., or variations of such structures) may be implemented on an individual shelf, antenna board, shelf back, divider or other supporting structure. The shelf configuration shown in FIG. 7, for example, may employ a loop, serpentine, slot (or combinations of this group) in shelf back 160, shelf divider 161, or both. Although the slot antenna structure (e.g., 152 (FIG. 8A)) having multiple slot arms has only been described herein as having arms intersecting at a single point, it should be apparent that the slot antenna structure may be implemented having any number of intersection points and slot arm configurations.

Although embodiments have been described in connection with the use of a particular exemplary shelf structure, it should be readily apparent that any shelf structure, rack, etc. or any structure may be used in selling, marketing, promoting, displaying, presenting, providing, retaining, securing, storing, or otherwise supporting an item or product or used in implementing embodiments of the invention.

Although specific circuitry, components, or modules may be disclosed herein in connection with exemplary embodiments of the invention, it should be readily apparent that any other structural or functionally equivalent circuit(s), component(s) or module(s) may be utilized in implementing the various embodiments of the invention.

The modules described herein, particularly those illustrated or inherent in, or apparent from the instant disclosure, as physically separated components, may be omitted, combined or further separated into a variety of different components, sharing different resources as required for the particular implementation of the embodiments disclosed (or apparent from the teachings herein). The modules described herein, may where appropriate (e.g., reader 50, primary controller 100, inventory control processing unit 130, data store 140, etc.) be one or more hardware, software, or hybrid components residing in (or distributed among) one or more local and/or remote computer or other processing systems. Although such modules may be shown or described herein as physically separated components (e.g., data store 140, inventory processing unit 130, primary controller 100, reader 50, gondola controller 30, shelf controller 40a, 40b, 40c, etc.), it should be readily apparent that the modules may be omitted, combined or further separated into a variety of different components, sharing different resources (including processing units, memory, clock devices, software routines, etc.) as required for the particular implementation of the embodiments disclosed (or apparent from the teachings herein). Indeed, even a single general purpose computer (or other processor-controlled device), whether connected directly to antennas 10, antenna boards 20, gondolas 70, or connected through a network 120, executing a program stored on an article of manufacture (e.g., recording medium such as a CD-ROM, DVD-ROM, memory cartridge, etc.) to produce the functionality referred to herein may be utilized to implement the illustrated embodiments.

One skilled in the art would recognize that inventory control processing unit 130 could be implemented on a general purpose computer system connected to an electronic network 120, such as a computer network. The computer network can also be a public network, such as the Internet or Metropolitan Area Network (MAN), or other private network, such as a corporate Local Area Network (LAN) or Wide Area Network (WAN), Bluetooth, or even a virtual private network. A computer system includes a central processing unit (CPU) connected to a system memory. The system memory typically contains an operating system, a BIOS driver, and application programs. In addition, the computer system contains input devices such as a mouse and a keyboard, and output devices such as a printer and a display monitor. The processing devices described herein may be any device used to process information (e.g., microprocessor, discrete logic circuit, application specific integrated circuit (ASIC), programmable logic circuit, digital signal processor (DSP), MicroChip Technology Inc. PlCmicro® Microcontroller, Intel Microprocessor, etc.).

The computer system generally includes a communications interface, such as an Ethernet card, to communicate to the electronic network 120. Other computer systems may also be connected to the electronic network 120. One skilled in the art would recognize that the above system describes the typical components of a computer system connected to an electronic network. It should be appreciated that many other similar configurations are within the abilities of one skilled in the art and all of these configurations could be used with the methods and systems of the invention. Furthermore, it should be recognized that the computer and network systems (as well as any of their components) as disclosed herein can be programmed and configured as an inventory control processing unit to perform inventory control related functions that are well known to those skilled in the art.

In addition, one skilled in the art would recognize that the “computer” implemented invention described herein may include components that are not computers per se but also include devices such as Internet appliances and Programmable Logic Controllers (PLCs) that may be used to provide one or more of the functionalities discussed herein. Furthermore, while “electronic” networks are generically used to refer to the communications network connecting the processing sites of the invention, one skilled in the art would recognize that such networks could be implemented using optical or other equivalent technologies. Likewise, it is also to be understood that the invention utilizes known security measures for transmission of electronic data across networks. Therefore, encryption, authentication, verification, and other security measures for transmission of electronic data across both public and private networks are provided, where necessary, using techniques that are well known to those skilled in the art.

It is to be understood therefore that the invention is not limited to the particular embodiments disclosed (or apparent from the disclosure) herein, but only limited by the claims appended hereto.

What is claimed as new and desired to be protected by Letters Patent of the United States is:

1. An antenna structure comprising at least one slot arm and a feed traversing the slot arm, wherein the antenna structure is coupled to a support structure supporting items having RFID tags.

2. The antenna structure as recited in claim 1, wherein the at least one slot arm has at least one end and a central section, wherein the width of the slot arm at the at least one end is greater than the width of the central section.

3. The antenna structure as recited in claim 1, wherein the feed is selected from the group consisting of a coaxial cable and a microstrip conductor.

4. The antenna structure as recited in claim 1, wherein the antenna structure is formed on a printed circuit board mounted on the support structure.

5. The antenna structure as recited in claim 1, wherein the at least one slot arm is formed in a metal plate incorporated in the support structure.

6. The antenna structure as recited in claim 1, wherein the at least one slot arm is made in a metal plate and the metal plate is part of the support structure, wherein the support structure is in the form of a shelf.

7. The antenna structure as recited in claim 1, wherein the at least one slot arm is in an approximately horizontal plane relative to a plane of the support structure.

8. The antenna structure as recited in claim 1, wherein the at least one slot arm is in an approximately vertical plane relative to a plane of the support structure.

9. The antenna structure as recited in claim 1, wherein the at least one slot arm is in a plane approximately parallel to a surface of the supporting structure.

10. An antenna system comprising:
at least two intersecting slot arms; and
a support structure, wherein said at least two intersecting slot arms are coupled to a support structure supporting items having RFID tags.

11. The antenna system as recited in claim 10, wherein each of the at least two intersecting slot arms has a proximal and distal end and a central section, wherein the width of the slot arm at the proximal and distal end is greater than the width of the central section.

12. The antenna system as recited in claim 10, wherein said at least two intersecting slot arms are substantially perpendicular to each other.

13. The antenna system as recited in claim 10, wherein the antenna structure is formed on a printed circuit board.

14. The antenna system as recited in claim 10, wherein said at least two intersecting slot arms include a total of five intersecting slot arms.

15. The antenna system as recited in claim 10, wherein the at least two intersecting slot arms are made in a metal plate and the metal plate is part of the support structure.

16. The antenna system as recited in claim 10, wherein the at least two intersecting slot arms are in an approximately horizontal plane.

17. Then antenna system as recited in claim 10, wherein the at least two intersecting slot arms are in an approximately vertical plane.

18. The antenna system as recited in claim 10, wherein the at least two intersecting slot arms is in a plane approximately parallel to a surface of the supporting structure.

19. An antenna system comprising a plurality of slot arms, a feed traversing the plurality of slot arms, and a plurality of antennae wherein the feed is connected to each of the plurality of antennae.

20. A method of displaying products having associated therewith RFID tags, the method comprising the steps of:
providing at least one RFID reader antenna with a slot geometry on a product support structure; and
placing at least one product on the product support structure such that an RFID tag associated with the at least one product is substantially parallel to a portion of the RFID reader antenna.

21. The method of claim 20, wherein said step of providing at least one RFID antenna comprises providing a single, planar antenna structure having a linear slot geometry with a feed at one end of the slot arm.

22. The method of claim 20, wherein said step of providing at least one RFID antenna comprises providing a single, planar antenna structure having a multi-armed slot geometry with a feed at the center of the slot geometry.

23. The method of claim 20, wherein said step of placing at least one product comprises the step of positioning the at least one product such that its associated RFID tag is substantially perpendicular to the length portion of a slot arm within the single, planar antenna.

24. The method of claim 20, wherein the product support structure comprises a horizontal shelf, for supporting a bottom portion of the at least one product, co-joined with a vertical backplane, for supporting a back portion of the at least one product, and wherein said step of providing at least one RFID reader antenna comprises incorporating a plurality of RFID reader antennas coupled to the horizontal shelf.

25. The method of claim 20, wherein the product support structure comprises a horizontal shelf, for supporting a bottom portion of the at least one product, co-joined with a vertical backplane, for supporting a back portion of the at least one product, wherein said step of providing at least one RFID reader antenna comprises incorporating a plurality of RFID reader antennas on or in the vertical backplane.

26. An RFID enabled system comprising:
a plurality of antennas, each having a geometry selected from a configuration selected from the group consisting of slot, serpentine, loop and patch;
at least one shelf switching board, said at least one shelf switching board being coupled to the plurality of antennas;
at least one gondola switching board said at least one gondola switching board being coupled to the plurality of antennas; and
an RFID reader, said reader providing a feed to said antennas and gondola switching boards.

27. The RFID enabled system of claim 26, further comprising a primary controller and an inventory control processing unit coupled to said primary controller.

28. The RFID enabled system of claim 27, wherein said inventory control processing unit is coupled to said primary controller through an electronic network.

29. The RFID enabled system of claim 26, wherein the feed is selected from the group consisting of a coaxial cable and a microstrip conductor.
